(19) United States
(12) Patent Application Publication
(10) Pub. No.: US 2003/0197023 A1
(43) Pub. Date: Oct. 23, 2003

(54) Dispensing apparatus and method thereof

(75) Inventor: Lo Kwok Chuen, Tsuen Wan (HK)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: GOOD YEAR ELECTRONIC MFG. CO., LTD., Tsuen Wan (HK)

(21) Appl. No.: 10/412,811

(22) Filed: Apr. 11, 2003

(30) Foreign Application Priority Data
Apr. 17, 2002 (CN) 02230788.5

(51) Int. Cl. B67D 5/44

(52) U.S. Cl. 222/109; 222/63; 222/383.1

(57) ABSTRACT

An apparatus for dispensing fluid comprising a container for retaining fluid to be dispensed; a dispensing means having an inlet, an outlet and a drawing mechanism with a forward drawing mechanism and a reverse drawing mechanism and a control mechanism coupled to the dispensing means. The fluid may be dispensed from the container when the forward drawing mechanism is in operation, and the residual fluid remaining around the outlet would be sucked back into the dispensing means or the container upon the termination of activation which triggers the operation of the reverse drawing mechanism for a pre-determined amount of time or volume.

### CROSS-REFERENCES TO RELATED APPLICATIONS

CLAIMS PRIORITY FROM CN APPLN. NO. 02230788.5

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

### Field of Invention

The present invention is related to devices for dispensing. In particular, the present invention is related to devices for dispensing fluid. It is also related to a method to prevent leakage during dispensing, particularly of fluids such as oil and aqueous liquid.

Dispensing containers for oil and aqueous liquid are one of the most common kitchenwares. However, many people have encountered a leakage of the oil or aqueous liquid when using conventional dispensing containers. One of the most typical dispensing containers for oil and aqueous liquid as shown in FIG. 1A require users to tilt the dispensing container to a certain angle so that the liquid are drawn from the container 2 by gravitational pull. When the container is resumed to its upright position after the application is done, the residue of the liquid would drip from the nozzle 4 of the container along the outside of the body of the container. Furthermore, the tilting of the container may result in a leakage of the liquid from the top cover 6 of the container if the top cover 6 is not properly fitted thereon.

Other designs such as the one shown in FIG. 1B has a lid 15 and a liquid collector 12 between the nozzle 10 and the storage chamber 14 of the liquid in a liquid dispensing container 8. The function of the liquid collector 12 is to collect excess liquid back to the storage chamber 14 after application by providing an opening 13 into the storage chamber 14. The design of the liquid collector 12 may prevent the dripping of liquid onto the outside of the container 8 when the container is relatively full. However, once a tilting angle of close to 90° from the vertical is required to dispense fluid when the container is near empty, fluid collected at the liquid collector 12 may actually leak onto the side.

Another design that is available in the market is using an S type dispensing nozzle as shown in FIG. 1C. With this type of liquid container 16, the surface tension of the liquid will pull back the liquid from the tip of the nozzle 17 through the vertical portion of the nozzle 18 when the container 16 has returned to the upright position after application. Again, the liquid may still drip from the tip of the nozzle 17 along the outside of the container body. Furthermore, if the sealing of the top cover 19 is poor, a leakage between the top cover 19 and the body of the container may also occur.

Another similar manual liquid dispenser container is a squeeze bottle. The dispensing of the liquid is driven by the squeezing motion of the user and the residual of the liquid that remains at the nozzle is sucked back into the container by the vacuum created when the user releases the squeeze bottle. Nonetheless, not all of the liquid residual would be sucked back to the container if the vacuum created is not strong enough. Furthermore, leakage between the top cover and the container is a common problem that results in worse leakage.

U.S. Pat. No. 5,823,402, an electrical fluid dispensing system is invented for transferring a fluid from a container to a reservoir using a pump. The fluid dispensing system described in this prior art includes a container, a pump, and an intake hose and an outlet hose operably coupled to the pump, wherein the pump and the intake hose are positioned in the container and the outlet hose exits through a container cap which matingly fits the neck of the container. This design can reduce the likelihood of spillage when transferring a liquid from a container to a reservoir. However, no leak-proof mechanism is provided.

It is therefore an object of the present invention to provide an apparatus for dispensing fluid from a container which includes both the forward and reverse drawing mechanism.

### BRIEF SUMMARY OF THE INVENTION

In accordance with the present invention, there is provided an apparatus for dispensing that includes a container for retaining fluid to be dispensed; a dispensing means having an inlet, an outlet and a drawing mechanism; and a control mechanism coupled to the dispensing means. The inlet is configured to allow fluid from the container to pass therethrough and into the dispensing means. The outlet is configured to allow the fluid to exit from the container when the drawing mechanism is operating appropriately. The drawing mechanism is provided with a forward drawing mechanism and a reverse drawing mechanism wherein fluid may be dispensed from the container when the forward drawing mechanism is in operation, and residual fluid remaining in and around the outlet would be sucked back into the dispensing means or the container when the reverse drawing mechanism is in operation. The control mechanism functions to control the order of drawing such that activation by a user of the dispensing means would initiate the forward drawing mechanism, and when the user terminates the activation command, this would trigger the reverse drawing mechanism for a pre determined amount of time or volume.

In the preferred embodiment, the control mechanism is provided with additional components such that activation of the dispensing means would first initiate the reverse drawing mechanism to suck for a pre-determined amount of time or volume before the forward drawing mechanism is initiated.

The advantage of the instant apparatus and method is that the reverse suction is automatically triggered for a pre-determined amount of time such that even if a very small volume is dispensed or the user accidentally triggers the dispensing mechanism, the amount of fluid left over near the spout of the outlet would automatically be removed from the outlet. The present system is therefore more reliable in preventing leakage than the prior art systems discussed.

### BRIEF DESCRIPTION OF THE DRAWINGS

FIG. 1A is a side view of a prior art dispensing container for dispensing fluid.

FIG. 1B is a side view of another prior art dispensing container for dispensing fluid.

FIG. 1C is a side view of yet another prior art dispensing container for dispensing fluid.

FIG. 2 is a cross sectional side view of an embodiment according to the present invention.

FIG. 3 is a top cross sectional view of the upper compartment of the embodiment as shown in FIG. 2.

FIG. 4 is a diagrammatic representation of the dispensing means according to the embodiment as shown in FIG. 2.

FIG. 5 is a front view of the same dispensing means as shown in FIG. 4.

FIG. 6 is an illustration of one exemplary electrical circuit according to one embodiment of the present invention.

FIG. 7 is a cross sectional side view of another embodiment of the present invention.

FIG. 8 is an exploded side view of the preferred embodiment of the present invention.

FIG. 9 is a cross sectional side view of the same embodiment as shown in FIG. 8.

FIG. 10 is an illustration of the electrical circuit according to the preferred embodiment of the present invention.

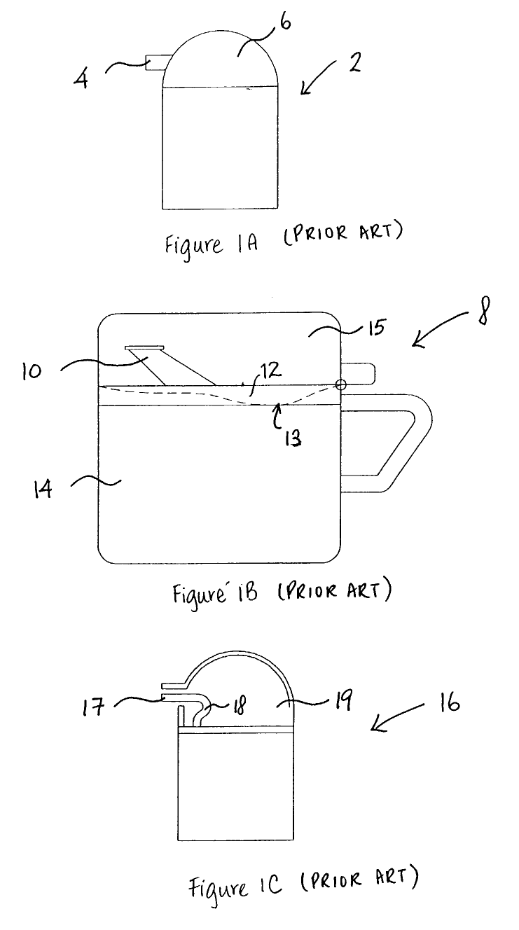

### DETAILED DESCRIPTION OF THE INVENTION

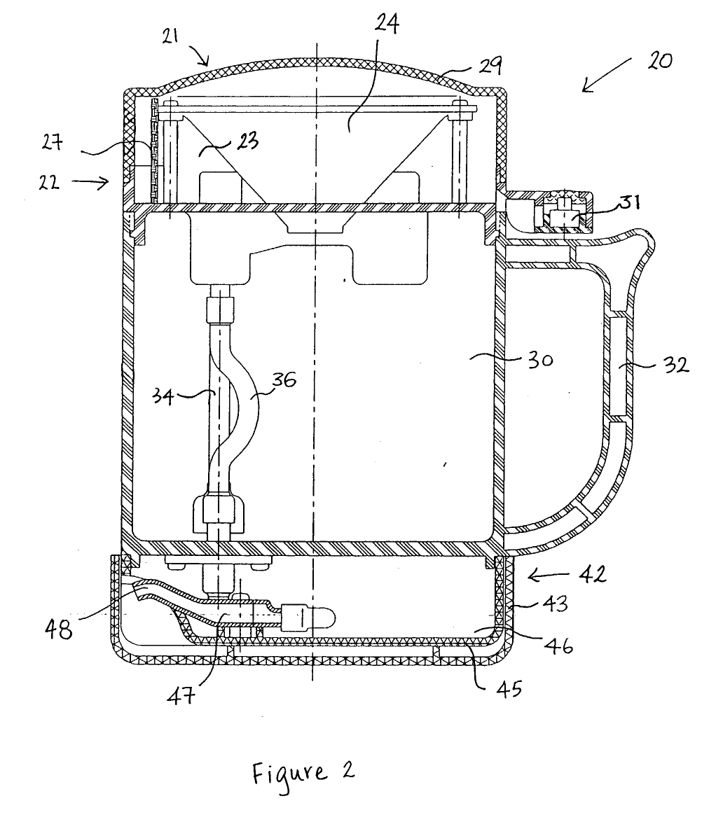

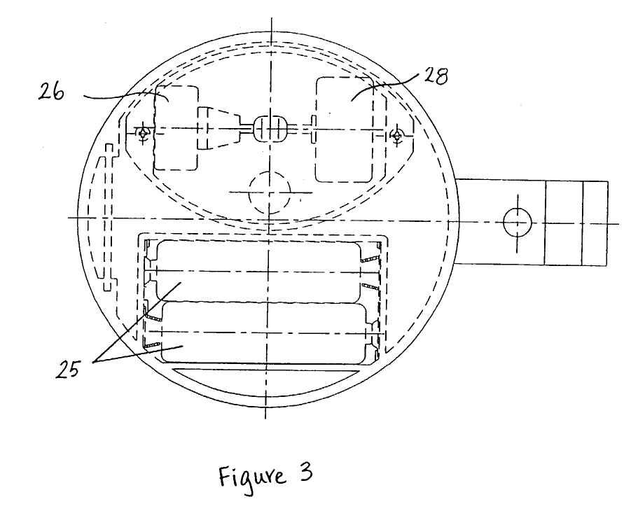

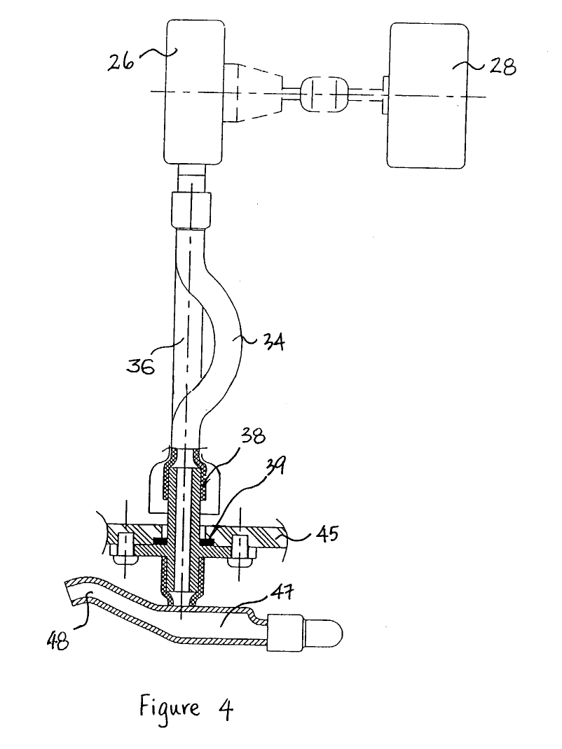

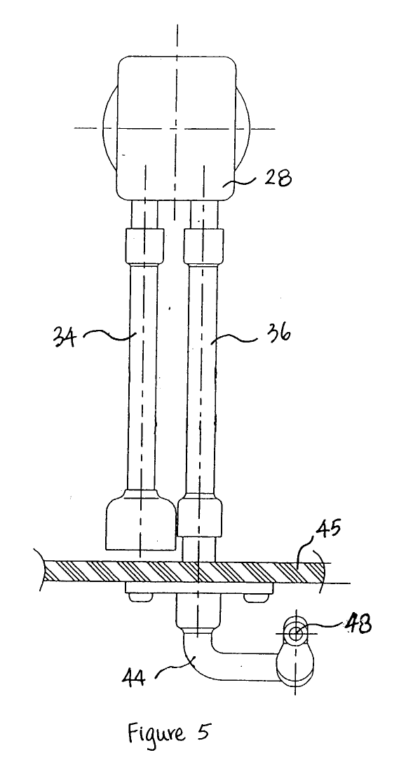

Referring first to FIGS. 2 and 3, one embodiment of an apparatus 20 for dispensing fluid includes an upper compartment 22, a storage chamber 30, a handle 32 on the side of the storage chamber 30 and a bottom compartment 42. The upper compartment 22 is provided with a dust cover 21 and an upper chamber 23 therebetween. In the upper chamber 23, there is located an electrical circuit board 27 and a funnel 24 with an opening so that the fluid can be poured into the storage chamber 30. A pump 26, a motor 28 and battery 25 are also provided therein. The inlet and outlet of the pump 26 are connected to one end of the drawing tube 34 and dispensing tube 36 located in the storage chamber 30, respectively. The other end of the drawing tube 34 and dispensing tube 36 are connected to outlet 48 in the bottom chamber 46 through a connector located therebetween. The spout of the outlet 48 extends out from the bottom cover 45 such that fluid can be poured out therefrom. The entire device sits on tray 43 which acts as a dust ‘cover’ for the dispensing spout of outlet 48. The detailed connections between the drawing tube 34 and dispensing tube 36 and the outlet 48 through the connector 38 are illustrated in FIGS. 4 and 5 which will be discussed later. On top of the handle 32 there is provided a switch 31 which is connected through the electrical wires 29 located on the side of the dust cover 21 to the power source 25 and the electrical circuit board 27 in the upper chamber 23.

Referring now to FIGS. 4 and 5, the dispensing tube 36 is connected to the outlet 48 via a connector 38, an o-ring 39 and an “L” shaped tube 44. The outlet 48 assumes a “˜” shape in which the spout of the outlet 48 is slanted upwards and then curved downwards to the storage space 47.

During operation, when a user switches on the device by pressing switch 31, the pump 26 will cause fluid stored in the storage chamber 30 to be drawn from the drawing tube 34 to the outlet 48 via the dispensing tube 36. The pump 26 can move in both directions to provide a forward drawing mechanism and a reverse drawing mechanism. When the pump is moving in the forward direction, the fluid may be dispensed from the storage chamber 30. After dispensing the desired volume of fluid, residual fluid remaining around the outlet 48 would be sucked back into the storage space 47 or the storage chamber 30 through the dispensing tube 36 when the reverse drawing mechanism is in operation.

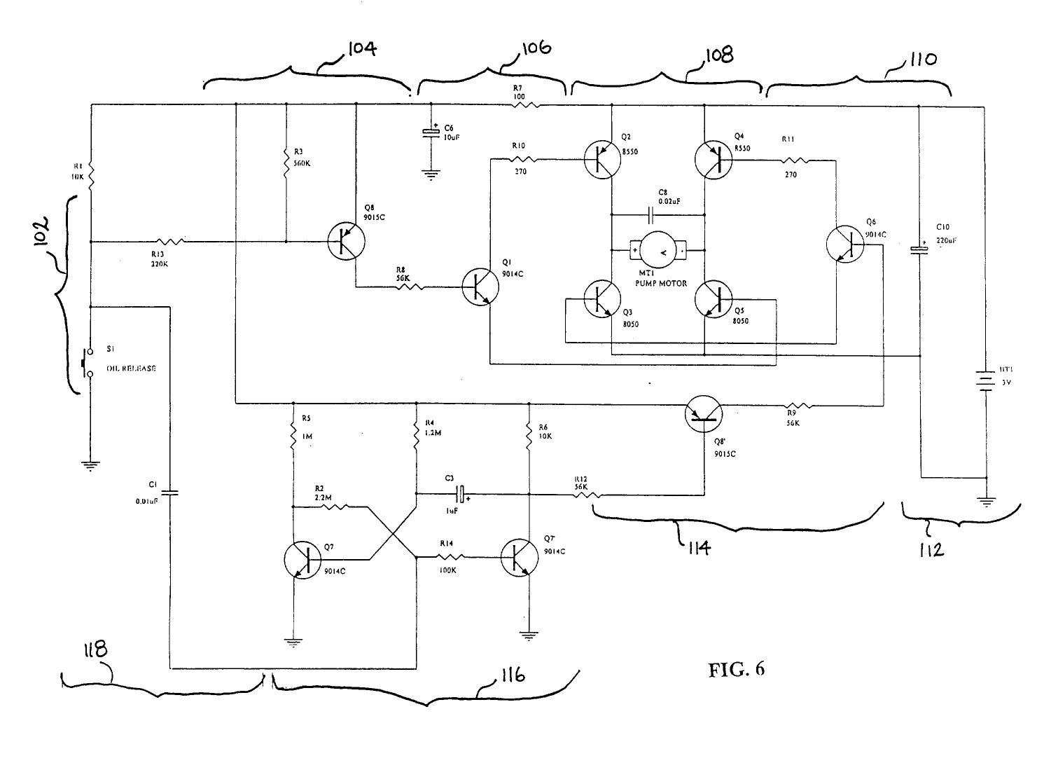

An examplary circuit diagram used as the control mechanism of the present embodiment is shown in FIG. 6. The circuit contains a switch for turning the system on and off 102, a forward control trigger 104, a forward control switch 106, a motor power driver 108, a reverse control switch 110, a battery 112, a reverse control switch driver 114, a reverse control timer 116 and a reverse trigger 118. The reverse control circuit is designed such that it would automatically be triggered upon the completion of the forward drawing mechanism. Thus, a user who switches on the device upon triggering the switch would cause the forward control mechanism to be initiated and the motor to start in the forward direction. Upon the user's termination of the dispensing function, the reverse mechanism will automatically be triggered via components of the reverse control switch 110, the reverse control switch driver 114, the reverse control timer 116 and the reverse trigger 118 to allow the reverse suction of the fluid from the outlet 48.

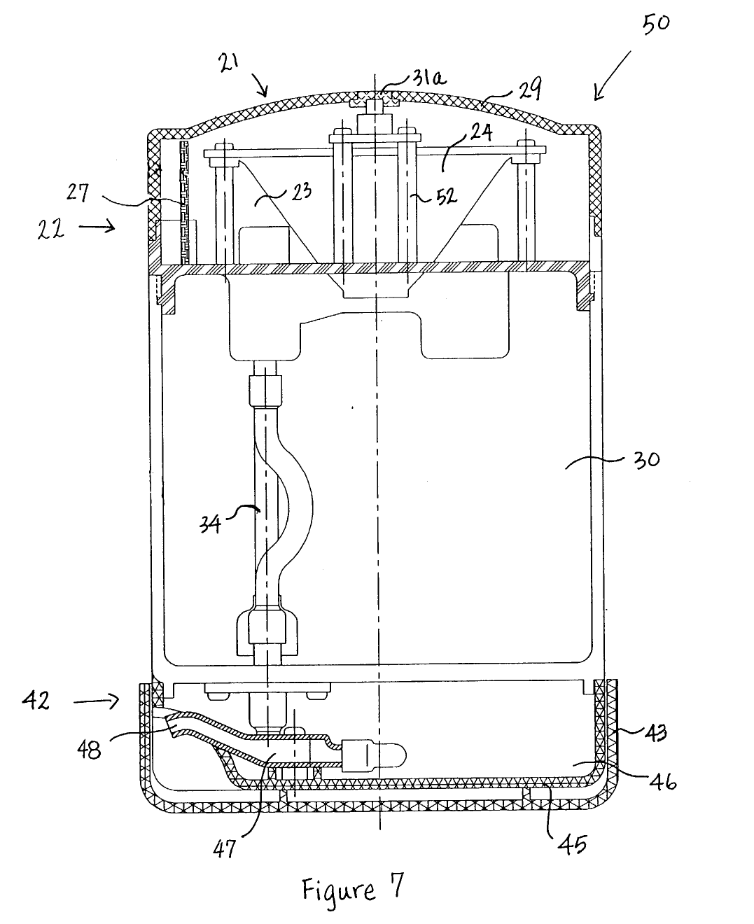

Referring now to FIG. 7, a cross sectional side view of another embodiment is described with like features given like reference numerals for ease of explanation. In this embodiment, apparatus 50 has no handle on the side of the storage chamber but instead there is a supporting bracket 52 installed in the upper compartment 22. The switch 31a in the present embodiment is fixed on top of the supporting bracket 52 and located at the tip of the dust cover 21. As an non-limiting example, the dust cover 21 can be made of plastic and/or with a rubber key top to allow triggering of the switch 31a by pressing onto the dust cover 21. Clearly, another non-limiting example is that the switch can be installed onto the dust cover 21 or the physical switch can be extended through a hole in the dust cover 21 such that the apparatus can be easily turned on or off. The operation of the present embodiment may be controlled by the same electronic circuitry as previously described in FIG. 6 in which the forward mechanism to dispense the fluid through the outlet 48 is activated by switching on the forwarding mechanism of the apparatus 50 and the reverse mechanism to suck back the residual fluid is activated when the switch is turned off (termination of the activation).

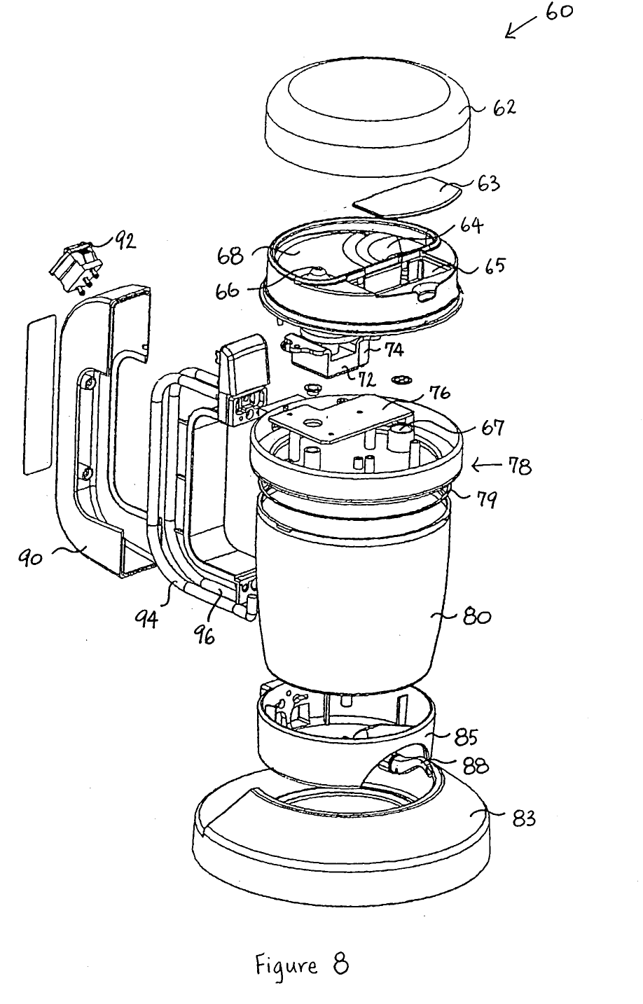

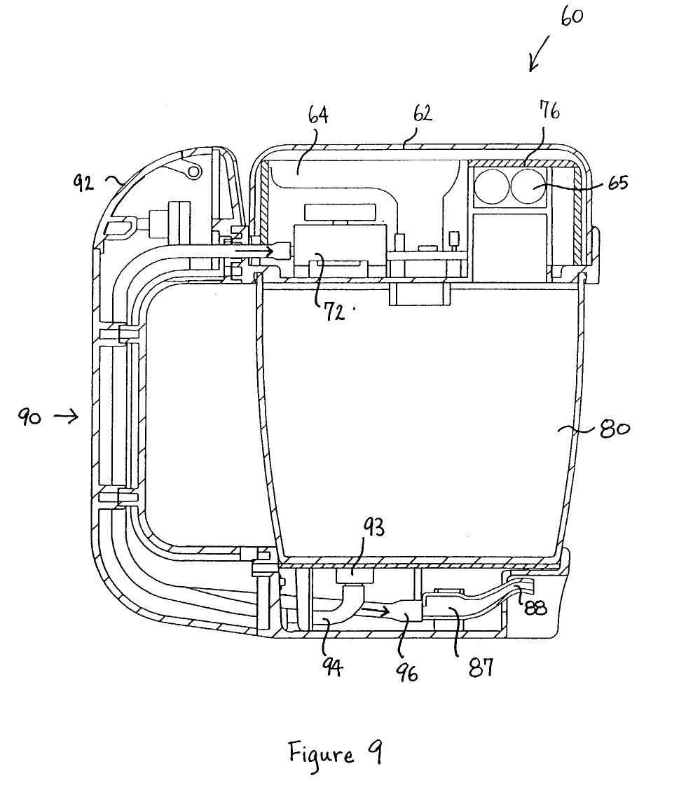

The preferred embodiment is shown in FIGS. 8 and 9 in which the drawing tube 94 and dispensing tube 96 are located inside the handle 90 instead of inside the storage chamber 80. The apparatus 60 is provided with an upper compartment 78 and a dust cover 62 thereon, a storage chamber 80, a handle 90 extending from the side of the storage chamber 80 and a bottom compartment 85 acting as the base. The upper compartment 78 is further provided with an air vent 66 and a chamber 65 with a lid 63 thereon for containing batteries. A reservoir 68 is used to receive fluid to be poured into the storage chamber 80 through an opening 67 of a funnel 64. A reversible pump 72, a motor 74 and an electrical circuit board 76 are also located in the upper compartment 78. Between the upper compartment 78 and the storage chamber 80, a rubber gasket 79 is fixed therebetween to better prevent leakage therefrom. The spout of the outlet 88 extends through the bottom compartment 85 such that fluid may be poured therefrom. The entire apparatus 60 sits on tray 83 which acts as a dust “cover” for the spout of the outlet 88. On the upper portion of the handle 90, a toggle switch 92 is provided to trigger the activation and termination of the apparatus 60. Inside the handle 90, the drawing tube 94 and the dispensing tube 96 are routed therein. The connections of the drawing tube 94 and the dispensing tube 96 are illustrated in FIG. 9.

During operation, when a user switches on the device by pressing the toggle switch 92, the pump 72 will cause fluid stored in the storage chamber 80 to be drawn from the drawing tube 94 to the outlet 88 via the dispensing tube 96. A filter 93 is provided at one end of the drawing tube 94 such that no particles will be drawn from the storage chamber 80 that may potentially clog the pump 72.

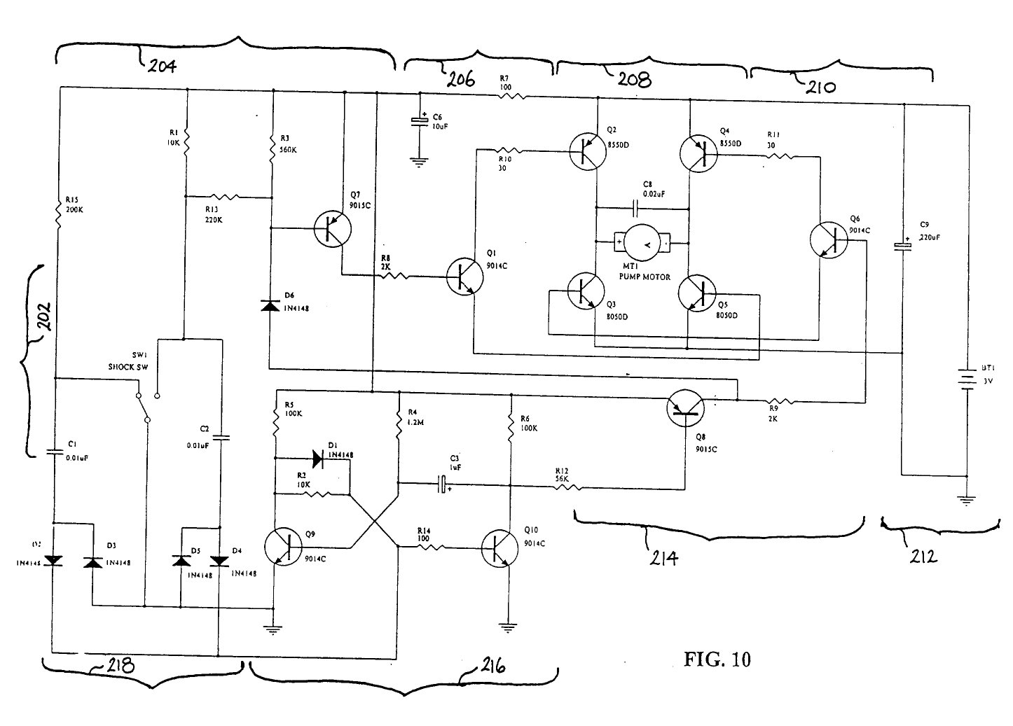

An examplary circuit used as the control mechanism of the apparatus 60 is shown in FIG. 10. The circuit contains a switch 202 for turning the system on and off, a forward control trigger 204, a forward control switch 206, a motor power driver 208, a reverse control switch 210, a battery 212, a reverse control switch driver 214, a reverse control timer 216 to control the time of reverse suction and a reverse trigger 218. The first reverse control circuit is designed such that it would automatically be triggered upon the activation of the device and the second reverse control circuit would automatically be triggered upon the completion of the forward drawing mechanism. Thus, a user who switches on the device upon triggering the switch 92 would cause the first reverse control mechanism to be initiated and the motor to start in the reverse direction. The first reverse mechanism would suck back the residual fluid that may be left over at the spout of the outlet 88 from a previous dispensing action. Then after a pre-determined amount of time (for example 1 second), the forward control mechanism would be initiated and the motor will move in the forward direction to dispense the desired volume of fluid. Upon the user's termination of the dispensing function by switching off the apparatus, the circuit will automatically be triggered via components SW1, C1 and D2 to allow the second reverse suction to suck back the residual fluid remained from the forward mechanism around the outlet 88. The additional reverse mechanism before the forward mechanism ensures that air pockets created in the dispensing tube 96 are cleared such that they would not cause “coughing” of fluid during the initial stage of forward dispensing due to the difference in compressability of air as opposed to fluid. Furthermore, a user accidentally activated the switch 92 would cause the reverse suction instead of immediate dispensing, allowing sufficient time for the user to react and terminate the action before dispensing actually occurs.

The forgoing descriptions of the embodiments according to the present invention have been presented for the purpose of illustration and description. It is not intended to be exhaustive or to limit the invention to the precise forms disclosed, as many modifications and variations are possible in the light of the teaching provided. For example, another embodiment of the present invention may have the pump and motor located at the bottom of the apparatus. The outlet can be located at the top of the apparatus. Furthermore, an apparatus can be provided with multiple switches such that one of them would activate the forward mechanism while another activates the reverse mechanism. It is therefore intended that the scope of the invention be defined by claims appended hereto and their equivalents.

What is claimed is:

1. An apparatus for dispensing comprising:
a) a container for retaining fluid to be dispensed;
b) a dispensing means having an inlet, an outlet and a drawing mechanism, said inlet configured to allow fluid from said container to pass therethrough into said dispensing means, said outlet configured to allow said fluid to dispense therefrom, said drawing mechanism provided with a forward drawing mechanism and a reverse drawing mechanism wherein fluid may be dispensed from said container when said forward drawing mechanism is in operation, and wherein residual fluid remaining around said outlet would be sucked back into said dispensing means or said container when said reverse drawing mechanism is in operation; and
c) a control circuit connected to said dispensing means to control the order of drawing such that activation of said dispensing means would initiate the forward drawing mechanism, and termination of activation would trigger operation of the reverse drawing mechanism for a pre determined amount of time or volume.

2. An apparatus according to claim 1 wherein said control circuit is provided with additional components such that activation of said dispensing means would first initiate the reverse drawing mechanism to suck for a pre-determined amount of time or volume before said forward drawing mechanism is initiated.

3. An apparatus according to claim 1 wherein said drawing mechanism comprises a motorized pump; an inlet channel connecting said inlet to said pump; and an outlet channel connecting said outlet to said pump; said apparatus further characterized in that a reservoir is provided in said outlet channel adjacent said outlet for holding fluid sucked back therethrough.

4. A method of leakproof dispensing using a apparatus for dispensing, said apparatus comprising a container for retaining fluid to be dispensed and a dispensing means having an inlet, an outlet and a drawing mechanism; said method comprising sequentially sucking fluid from said outlet back into said apparatus; dispensing fluid from said container; and again sucking residual fluid collected in and around said outlet back into said apparatus.
